(19) United States
(12) Patent Application Publication
(10) Pub. No.: US 2023/0059459 A1
(43) Pub. Date: Feb. 23, 2023

(54) Money Dispensing Trash Receptacle Assembly

(71) Applicant: Nicholas Slater, Lake Matthews, CA (US)

(72) Inventor: Nicholas Slater, Lake Matthews, CA (US)

(21) Appl. No.: 17/891,378

(22) Filed: Aug. 19, 2022

Related U.S. Application Data
(60) Provisional application No. 63/234,786, filed on Aug. 19, 2021.

(51) Int. Cl. G07F 7/00; G07F 7/06; B65F 1/14

(52) U.S. Cl. CPC G07F 7/005; G07F 7/0609; B65F 1/14; B65F 2210/138; B65F 2210/139; B65F 2210/1443; B65F 2210/184

(57) ABSTRACT

The present invention relates to a novel trash can configured to provide money to users in exchange for trash/litter and recyclable items. The trash can has separate bins for collecting trash and recyclables; a weight sensor for determining a weight of the collected trash and recyclables; a processor for determining cash value corresponding to the weight of the collected trash and recyclables; a coin tray for storing coins; a bill tray for storing bills; a coin slot configured to dispense coins from the coin tray; and a bill slot for dispensing bills from the bill tray for providing a monetary amount to a user in exchange for depositing trash and recyclables. The bins can be removed, and the trays can be refilled by municipal authorities. In some embodiments, the trash can assembly has a screen display for displaying the weight of items and corresponding monetary amount.

### CROSS-REFERENCE TO RELATED APPLICATION

The present application claims priority to, and the benefit of, U.S. Provisional Application No. 63/234,786, which was filed on Aug. 19, 2021 and is incorporated herein by reference in its entirety.

### FIELD OF THE INVENTION

The present invention relates generally to the field of trash can assemblies. More specifically, the present invention relates to a novel trash can that enables users to exchange collected litter and recyclable items for money. The trash can assembly weighs collected litter and recyclable items using a weight sensor and determines a cash value corresponding to the weight of the items. The cash value is dispensed in the form of coins from a coin slot and cash from a bill slot for providing financial incentives to users. Accordingly, the present disclosure makes specific reference thereto. Nonetheless, it is to be appreciated that aspects of the present invention are also equally applicable to other like applications, devices, and methods of manufacture.

### BACKGROUND

By way of background, trash containers, garbage bins, and trash cans are effectively placed around a building or home and are the first step toward safe material handling and building a hygienic environment. Trash cans are configured to keep garbage locked in for subsequent collection by authorities, hence preventing environmental hazards while keeping the environment neat and tidy. Conventional trash/garbage cans are in the form of a container, usually of metal or plastic, for disposal of waste material. Generally, in both residential and commercial settings, trash cans and other receptacles often have lids or doors for protecting or preventing the escape of the contents of the receptacle, and for prohibiting entry by unwanted pests. The lid or door can also inhibit or prevent odors from escaping and can hide the items within the receptacle from view. The garbage cans are usually placed by municipalities for use in public areas but are not always used by individuals for disposing of waste material. This leads to poor waste management and may cause land and air pollution.

Due to lack of use of trash containers, garbage bins, and trash cans, uncontained trash litters the streets causing pollution, germs, and unhygienic environment. There is a desire for a method by which individuals can be motivated to use trash and garbage cans, and a financial reward may be the motivation that most individuals need.

Individuals are also reluctant to use recycling bins and may throw recyclable items on streets, outside homes and business areas, and more, which adds to the litter problem. Also, placement of separate garbage and recycling bins consume space and are often difficult to differentiate by individuals. Therefore, individuals desire an improved trash bin that can be used for receiving both trash and recyclable items.

Therefore, there exists a long-felt need in the art for an improved trash bin that can be used countrywide in every city, town, mall, etc., to improve sanitation. There is also a long-felt need in the art for a trash bin that incorporates two separate bins that can separate trash and recyclable materials. Additionally, there is a long-felt need in the art for a trash bin that motivates individuals to use the bin for dropping litter and recyclable materials therein. Moreover, there is a long-felt need in the art for an improved trash bin that helps in improving hygiene, sanitation, and cleanliness. Further, there is a long-felt need in the art for a trash bin that is in the form of a vending machine offering financial rewards to individuals using the trash bin. Furthermore, there is a long-felt need in the art for a garbage bin that can be deployed by municipalities in rural, suburban, and metropolitan areas in a reduced space. Finally, there is a long-felt need in the art for a trash can in the form of a vending machine for collecting trash/litter and recyclable materials and providing money in exchange to users.

The subject matter disclosed and claimed herein, in one embodiment thereof, comprises a trash can assembly configured to dispense money in exchange for received trash and/or recyclable materials. The trash can assembly promotes use of the trash can for depositing trash and recyclable materials. The assembly further comprises separate and independent bins for receiving and storing trash items and recyclable items; a weight sensor associated with each of said bins, the weight sensor is configured to weigh items received in said bins; a processor for determining an exchange cash value for the received items based on weight of the items; separate trays for storing a plurality of coins and a plurality of bills; a coin slot for dispensing coins from the coin tray; a bill slot for dispensing bills from the bill tray, wherein said coins and said bills are dispensed based on the exchange cash value determined by the processor.

In this manner, the trash can assembly of the present invention accomplishes all of the foregoing objectives and provides users with a reverse vending machine for use by municipalities in rural, suburban, and metropolitan areas. The trash can assembly enables users to exchange collected litter and recyclable items for money and offers a financial incentive that conventional trash cans do not. The trash can assembly is a unique and effective solution for litter control that can be used in any major metropolitan city or small town in the country for maintaining hygiene and cleanliness.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash can assembly configured to dispense money in exchange of received trash and/or recyclable materials. The trash can assembly further comprises a trash bin for receiving and storing trash items; a recycling bin for receiving and storing recyclable items; a weight sensor associated with each of said bins, the weight sensor is configured to weigh items received in said bins; a processor for determining an exchange monetary value for the received items based on weight of the items; a coin tray for storing a plurality of coins and a bill tray for storing a plurality of bills; a coin slot disposed on a front surface of the trash can for dispensing coins from the coin tray; a bill slot disposed on front surface of the trash can for dispensing bills from the bill tray, wherein said coins and said bills are dispensed based on the exchange monetary value determined by the processor.

In yet another embodiment, a trash can machine configured to dispense money in exchange of collecting trash or recyclable material is disclosed. The trash can machine includes a trash bin for receiving trash items through a slot positioned on a top surface of the trash can, a recyclable items bin for receiving recyclable items through another slot positioned on top surface of the trash can, a weight sensor for weighing trash items and recyclable items received by respective bins, a processor for determining a cash value of the received trash items and recyclable items based on a determined weight, a display screen positioned on a front surface of the trash can for displaying the weight of the items and a cash value corresponding to the weight of the items, a coin slot for dispensing coins and a bill slot for dispensing bills corresponding to the determined cash value.

In yet another embodiment, a clean box is disclosed. The clean box is roughly the size of a typical vending machine, but its height is closer to that of a stove, for example, the clean box further has a first bin for trash and a second bin for recyclables, the bins have covers at the top that function as trap doors to prevent escape of items from said bins; a processor for determining value of trash or recycled materials based on a weight of the items detected by a weight sensor; a coin slot connected to a coin tray for dispensing coins and a bill slot connected to a bill tray for dispensing cash, wherein the dispensed money is equivalent to the value determined by the processor.

In yet another embodiment, a method of offering a financial incentive in exchange for litter and recyclable items is disclosed. The method includes the steps of: providing a trash can; receiving, by the trash can, trash or recyclable items; weighing, by a weight sensor, the received trash and/or recyclable items; determining, by a processor, a cash value of the received trash or recyclable items corresponding to the determined weight; and, dispensing, by a coin slot and a bill slot, a determined cash value for financial incentive to users.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a combined trash can and vending machine of the present invention in accordance with the disclosed architecture;

FIG. 2 illustrates an internal perspective view of the improved trash can of the present invention in accordance with the disclosed architecture;

FIG. 3 illustrates a side perspective view of the trash and recyclable material exchange box of the present invention in accordance with the disclosed architecture;

FIG. 4 illustrates another side perspective view of the trash and recyclable material exchange box of the present invention in accordance with the disclosed architecture;

FIG. 5 illustrates a front view of the exemplary trash can of the present invention in accordance with the disclosed architecture;

FIG. 6 illustrates a functional block diagram showing connection of a processor of the trash can with other electric components in accordance with the disclosed architecture;

FIG. 7 illustrates a flow diagram depicting a process of dispensing coins and/or bills by the improved trash can machine of the present invention in accordance with the disclosed architecture; and

FIG. 8 illustrates a planar view showing connection of trays with the slots for dispensing money for providing financial incentive to a user in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved trash bin that can be used countrywide in every city, town, mall, etc., to improve sanitation. There is also a long-felt need in the art for a trash bin that incorporates two separate bins for separating trash from recyclable materials. Additionally, there is a long-felt need in the art for a trash bin that motivates individuals to use the bin for dropping litter and recyclable materials therein. Moreover, there is a long-felt need in the art for an improved trash bin that helps in improving hygiene, sanitation, and cleanliness. Further, there is a long-felt need in the art for a trash bin that is in the form of a vending machine offering financial rewards to individuals using the trash bin. Furthermore, there is a long-felt need in the art for a garbage bin that can be deployed by municipalities in rural, suburban, and metropolitan areas in reduced spaces. Finally, there is a long-felt need in the art for a trash can in the form of a vending machine for collecting trash/litter and recyclable materials and providing money in exchange to users.

The present invention, in one exemplary embodiment, is a novel method of offering a financial incentive in exchange foe litter and recyclable items. The method includes the steps of: providing a trash can; receiving, by the trash can, trash or recyclable items; weighing, by a weight sensor, the received trash or recyclable items; determining, by a processor, the cash value of the received trash or recyclable items corresponding to the determined weight; and, dispensing, by a coin slot and a bill slot, a determined cash value for financial incentive to users. The method further comprises displaying a weight of the items and the cash value on a screen disposed on a front surface of the trash can.

The embodiments disclosed herein are disclosed in the context of trash cans (also referred to as garbage bins, refuse containers, or otherwise) because they have particular utility in this context. However, the inventions disclosed herein can be used in other contexts as well, such as in any other type of receptacle. Further, the inventions are described herein in reference to various embodiments and drawings. It will be appreciated by those skilled in the art that variations and improvements may be accomplished in view of these teachings without deviating from the scope and spirit of the invention.

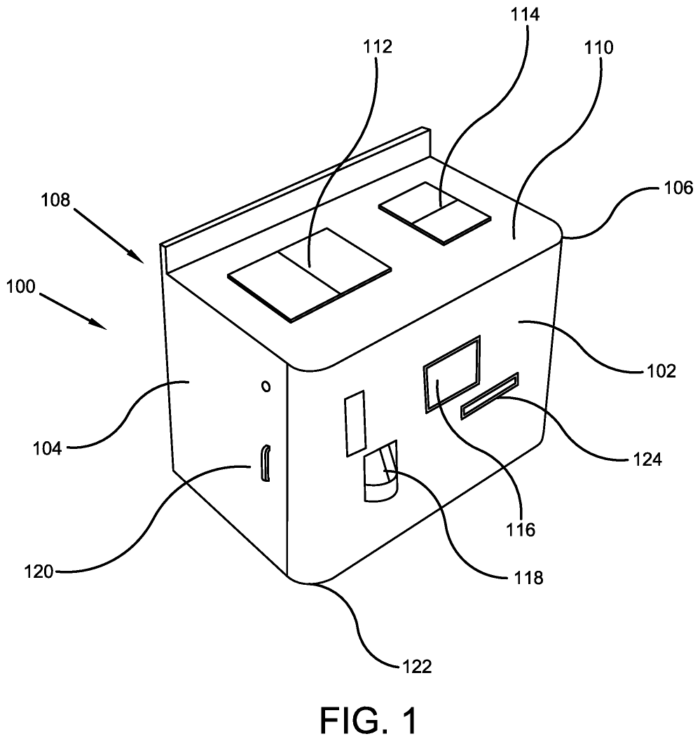

Referring initially to the drawings, FIG. 1 illustrates a perspective view of one potential embodiment of the combined trash can and vending machine of the present invention in accordance with the disclosed architecture. The trash can 100 of the present invention is configured to be deployed by municipalities in rural, suburban, and metropolitan environments, and in both residential and business areas for collecting trash/litter and recyclable materials in exchange for money. More specifically, the trash can 100 is made of steel or plastic and is roughly the size of a typical vending machine but has a relatively shorter height. The trash can 100 has a front surface 102, a pair of side surfaces 104, 106, a rear surface 108, and a top surface 110. The top surface 110 has a first slot 112 for receiving trash and a second slot 114 for receiving recyclable material. The slots 112, 114 have trap doors that prevent individuals and animals from taking anything out of the machine once it has been discarded therein.

The front surface 102 has a smart screen display 116 for displaying details of the deposited items and money details exchanged corresponding to the received items. A coin slot 118 is disposed on the front surface 102 and is used for dispensing coins or money in exchange for the litter and/or recyclable items. For dispensing notes or bills, a separate slot 124 is provided. The vending machine 100 is configured to weigh the items received from a user and accordingly, based on the weight of the items, an exchange money amount is dispensed from the slot 118. Details of the weighing of the items and storage of coins are described later in the disclosure.

The side surface 104 of the trash can 100 includes a hinged door 120 configured to be locked by municipal authorities using a lock which can be opened using a key or using alternative means such as biometrics. The hinged door 120 is used for collecting trash/litter and recycled products by the municipality authorities and provides authenticated access to the bins of the trash can 100. The hinge of the hinged door 120 can be provided along an edge of the door 120 and can be configured to activate pivotal opening of the door 120. One or more wheels 122 can be provided to facilitate moving the trash can 100 along a rolling surface. While the above-described embodiment is directed to the deployment of the inventive trash can 100, it is understood that the trash can 100 can have any additional parts or components for improving functionality of the trash can 100.

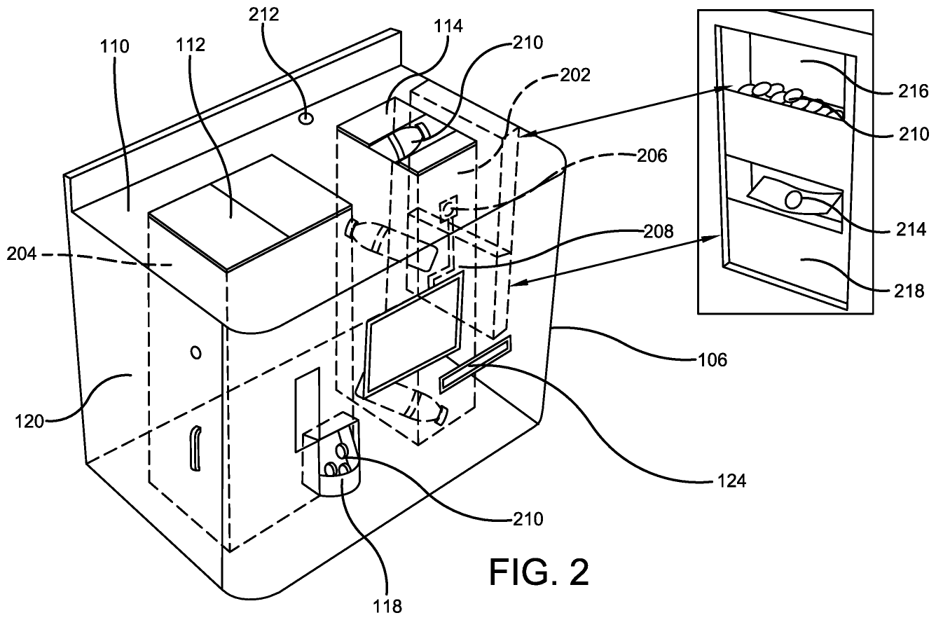

FIG. 2 illustrates an internal perspective view of the improved trash can of the present invention in accordance with the disclosed architecture. The trash can 100 has a recycling material bin 202 coupled to the second slot 114 and a separate trash bin 204 coupled to the first slot 112. The bins 202, 204 are independent and separate and can be removed from inside the trash can 100 by municipality authorities. Both the bins 202, 204 have a weight sensor 206 for weighing the items received by the respective bins. The weight sensor 206 can be a type of transducer, specifically a weight transducer, and is configured to convert the input weight into an electrical output signal for display on the display screen 116. Separate weight sensors may be disposed inside each bin, or a single weight sensor may work for both the bins.

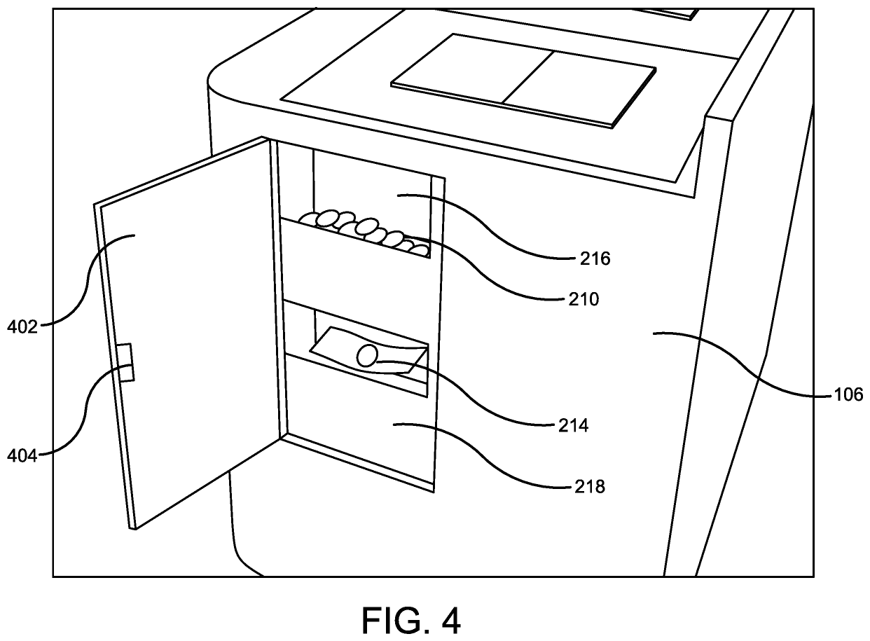

More specifically, the weight sensor is coupled to a flat surface 208 in the recycling material bin 202 so that the recycling item(s) 210 dropped by a user, when landing on the flat surface 208, are weighed by the weight sensor 206. Based on the weight of the recyclable items, a processor (described in FIG. 4) calculates an amount to be dispensed in exchange for the received items. Similarly, the trash received by the trash bin 204 is weighed and an exchange amount is automatically calculated by the vending machine 100. Based on the exchange amount, coins 210 are dispensed from the coin slot 118 and bills are dispensed from the money slot 124. All the items received by the bins 202, 204 are deposited at their respective bottom surface and can be removed by municipal authorities via the door 120.

An LED light 212 is disposed on the top surface 110 of the trash can 100 and is configured to illuminate in a green light when there is space in the bins 202, 204 to receive more items and is configured to illuminate in a red light when the bins 202, 204 have accumulated trash to at least 85% of the total capacity.

The trash can 100 is also configured to store coins 210 and bills 214 for dispensing in exchange for trash and recyclable materials. The coins 210 are stored in a coin tray 216 and the bills 214 are stored in a bill tray 218, wherein the coin tray 216 and the bill tray 218 are stored along the side surface 106. The coin tray 216 and the bill tray 218 are removable and can be refilled by municipal authorities in a manner like an ATM machine.

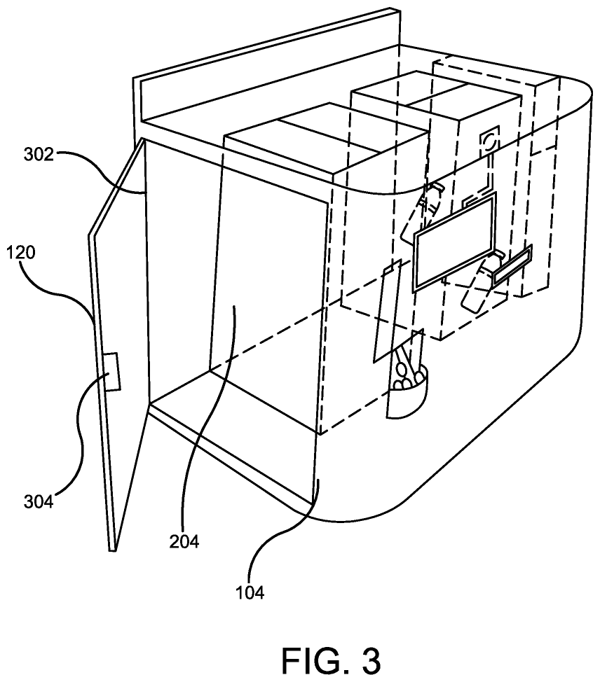

FIG. 3 illustrates a side perspective view of the trash and recyclable material exchange box 100 of the present invention in accordance with the disclosed architecture. The side surface 104 has the hinged door 120 that is hinged along the edge 302 and is latched using the latch 304. The hinged door 120 can be opened by opening the latch 304 for accessing the bins 202, 204 to remove the stored items from inside the trash can 100.

The latch 304 can be a manual lock or can be an electronic lock which can be opened using biometrics or a pin code for secure access. The trash can 100 is inoperable when the door 120 is in an open state as shown in FIG. 3.

FIG. 4 illustrates another side perspective view of the trash and recyclable material exchange box 100 of the present invention in accordance with the disclosed architecture. The coin tray 216 and the bill tray 218 are configured to store coins 210 and bills 214 respectively and can be removed by opening a small, hinged door 402 positioned on the side surface 106 of the trash can 100. The door 402 is latched to the side surface 106 using an electronic latch 404 which is configured to be opened using biometrics or a pin code for access by municipality authorities.

The coins and the bills contain enough money in the trays 216, 218 corresponding to the storage space of the bins 202, 204 and in one exemplary embodiment, the trays 216, 218 provide money while the bins 202, 204 have space to accommodate items.

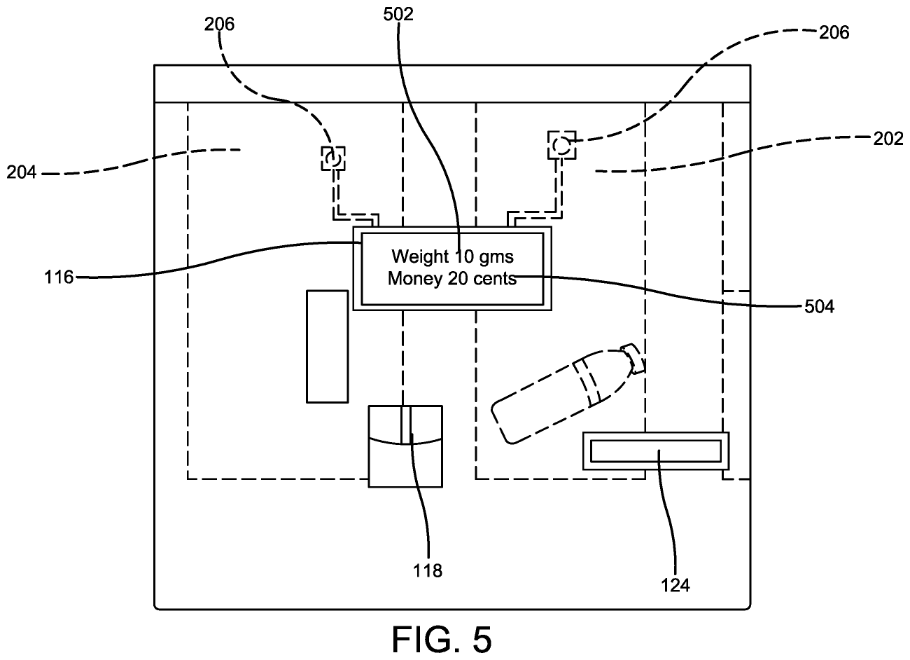

FIG. 5 illustrates a front view of the exemplary trash can 100 of the present invention in accordance with the disclosed architecture. The display screen 116 is configured to display the weight of the items received by any of the bins 202, 204. As illustrated, the screen 116 displays “weight 10 gms” 502 which is configured to be displayed based on the weight detection by the weight sensor as discussed in FIG. 2. It should be noted that in FIG. 5, two separate weight sensors are shown for more clarity. The screen 116 is also configured to display equivalent monetary amount like “money 20 cents” 504 which is based on the exchange rate performed by the processor of the trash can 100. The screen 116 may also be configured to display additional information such as remaining space in the bins 202, 204, and more.

It should be noted that the coin slot 118 and the bill slot 124 are internally connected to the coin tray and the bill tray, respectively, enabling the transfer of coins and bills for dispensing. Further, the items when dropped in the bins 202, 204 are stored at the bottom of the bins.

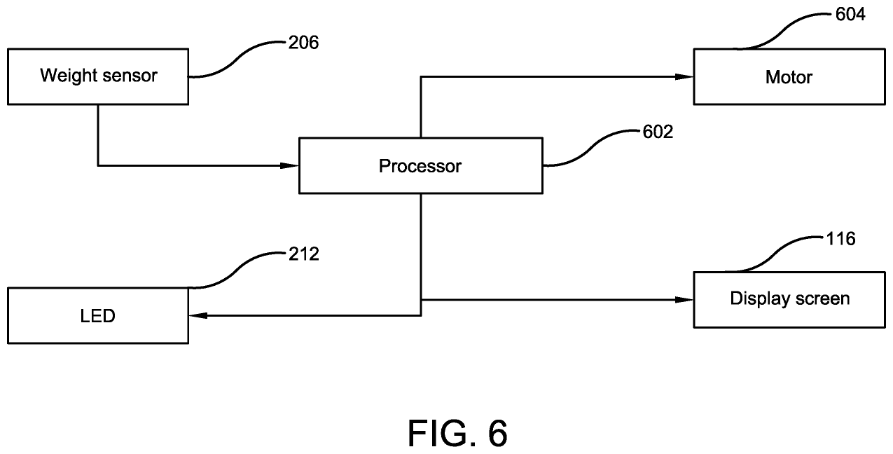

FIG. 6 illustrates a functional block diagram showing connection of the processor 602 of the trash can 100 with other electronic components in accordance with the disclosed architecture. The weight sensor 206 is configured to detect the weight of the items received from the slots and an electronic signal is transmitted to the processor 602. The processor 602 upon receiving the detected weight, classifies the items and based on an internal stored algorithm, calculates an exchange amount for dispensing through the coin slot and/or bill slot. Simultaneously, the processor 602 sends the information to the display screen 116 to display weight and money information (i.e., monetary value) as shown in FIG. 5. The processor 602 can be implemented as a combination of software and hardware such as microprocessor, microcontroller, or any integrated circuit.

For dispensing coin and/or bills, a motor 604 connected to the trays is actuated enabling transfer of coins and/or bills from the trays to the dispensing slots. It should be appreciated that the process of weighing items, calculating money, and dispensing money is automated and does not require manual intervention. The process of dispensing money in exchange for collected litter and recyclable items promotes use of the trash can 100 and helps in maintaining hygiene and cleanliness. Accordingly, the clean box 100 is a unique and effective solution for litter control that can be used in any major metropolitan city or small town in the country.

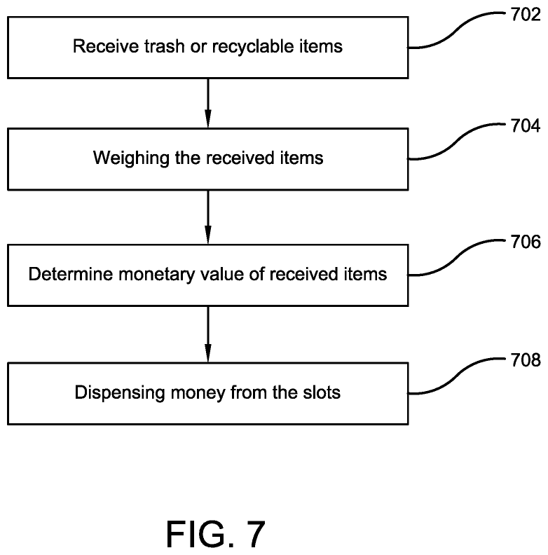

FIG. 7 illustrates a flow diagram depicting a process of dispensing coins and/or bills by the improved trash can machine of the present invention in accordance with the disclosed architecture. Initially, the trash or recyclable items are received in respective bins of the trash can (Step 702). Based on the items received, a weight of the received items is measured by the weight sensor (Step 704). Based on stored pricing algorithms and computation, a monetary value is determined and displayed along with the weight of the items on the display screen of the garbage can (Step 706). Finally, the money is transferred from the trays and dispensed from the dispensing slots (Step 708).

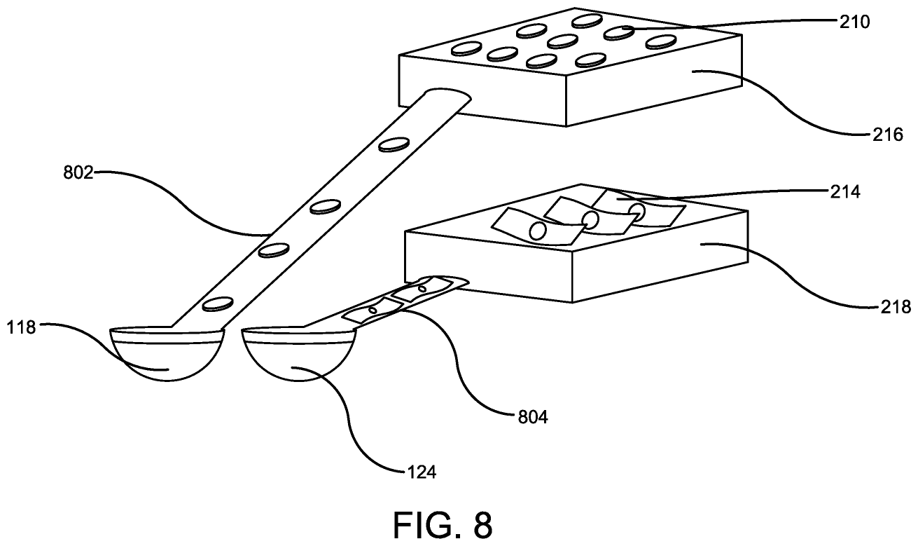

FIG. 8 illustrates a planar view showing connection of trays with the slots for dispensing money for providing financial incentive to a user in accordance with the disclosed architecture. As illustrated, the coin tray 216 is connected to the coin slot 118 via a first conduit 802 and is used for carrying the coins from the coin tray 216 to the coin slot 118. Similarly, the bill tray 218 is connected to the bill slot 124 via a second conduit 804 and is used for carrying the bills from the bill tray 218 to the bill slot 124. It should be appreciated that the motor 604 can be used for transferring coins and bills to the respective slots.

In certain embodiments, the trash can is made from a plastic material or steel. Some embodiments are made of softer and/or more malleable plastics, such as high impact polypropylene. Further, the trash can is waterproof and does not allow water to pass inside the bins when the slots on the top surface are covered.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “garbage can”, “trash can assembly”, “trash can”, “improved trash can machine”, “trash and recyclable material exchange box”, and “combined trash can and vending machine” are interchangeable and refer to the combined trash can and vending machine 100 of the present invention.

Notwithstanding the foregoing, the combined trash can and vending machine 100 of the present invention can be of any suitable size and configuration as is known in the art without affecting the overall concept of the invention, provided that it accomplishes the above-stated objectives. One of ordinary skill in the art will appreciate that the combined trash can and vending machine 100 as shown in the FIGS. are for illustrative purposes only, and that many other sizes and shapes of the combined trash can and vending machine 100 are well within the scope of the present disclosure. Although the dimensions of the combined trash can and vending machine 100 are important design parameters for user convenience, the combined trash can and vending machine 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash and monetary exchange container comprising:
a trash and recyclable receptacle having a front surface, a pair of side surfaces, a rear surface, and a top surface;
wherein said top surface having a first slot for receiving trash and a second slot for receiving recyclables;
wherein said first slot having a first trap door and said second slot having a second trap door for preventing removal of the received trash and the received recyclables;
a screen display for displaying details of the received trash and the received recyclables;
a coin slot for dispensing coins;
a bill slot for dispensing dollar bills;
a weight sensor for weighing the received trash and the received recyclables;
a processor for exchanging a weight of the received trash and a weight of the received recyclables into a monetary amount; and
further wherein said monetary amount is dispensed from said coin slot and said bill slot.

2. The trash and monetary exchange container of claim 1 further comprising a display for displaying details of the received trash and the received recyclables.

3. The trash and monetary exchange container of claim 2, wherein said displaying details includes said weight of the received trash or said weight of the received recyclables.

4. The trash and monetary exchange container of claim 3, wherein said displaying details includes said monetary amount exchanged from said weight of the received trash and said weight of the received recyclables.

5. The trash and monetary exchange container of claim 4, wherein said weight sensor is a weight transducer to convert said weight of the received trash and said weight of the received recyclables into an electrical output signal for display on said screen display.

6. The trash and monetary exchange container of claim 5, wherein said first slot coupled to a first trash bin and said second slot coupled to a second recycling bin.

7. The trash and monetary exchange container of claim 5, wherein said top surface having an LED light illuminating in a first color when there is space remaining in said first trash bin or said second recycling bin.

8. The trash and monetary exchange container of claim 7, wherein said LED light illuminating in a second color when said first trash bin or said second recycling bin have reached a predeterminable level of capacity.

9. The trash and monetary exchange container of claim 8 further comprising a coin tray for storing coins and a bill tray for storing bills.

10. The trash and monetary exchange container of claim 9, wherein said coin tray and said bill tray are removable for replenishing.

11. A trash and monetary exchange container comprising:
a trash and recyclable receptacle having a front surface, a pair of side surfaces, a rear surface, and a top surface;
wherein at least one of said top surface and said front surface having a first slot for receiving trash and a second slot for receiving recyclables;
wherein said first slot having a first trap door for preventing removal of the received trash;
wherein said second slot having a second trap door for preventing removal of the received recyclables;
a coin slot for dispensing coins;
a bill slot for dispensing dollar bills;
a weight sensor for weighing the received trash and the received recyclables;
a screen display for displaying a weight of the received trash and a weight of the received recyclables;
a processor for exchanging said weight of the received trash and said weight of the received recyclables into a monetary amount;
wherein said monetary amount is dispensed from said coin slot and said bill slot; and
further wherein said screen display includes said monetary amount exchanged from said weight of the received trash and said weight of the received recyclables.

12. The trash and monetary exchange container of claim 11, wherein said weight sensor is a weight transducer to convert said weight of the received trash and said weight of the received recyclables into an electrical output signal for display on said screen display.

13. The trash and monetary exchange container of claim 12, wherein said first slot coupled to a first trash bin and said second slot coupled to a second recycling bin.

14. The trash and monetary exchange container of claim 13, wherein said top surface having an LED light illuminating in a first color when there is space remaining in said first trash bin or said second recycling bin.

15. The trash and monetary exchange container of claim 14, wherein said LED light illuminating in a second color when said first trash bin or said second recycling bin have reached a predeterminable level of capacity.

16. The trash and monetary exchange container of claim 15 further comprising a coin tray for storing coins and a bill tray for storing bills.

17. The trash and monetary exchange container of claim 16, wherein said coin tray and said bill tray are removable for replenishing.

18. A method of exchanging money for trash and recyclables comprising the steps of:
receiving trash or recyclables in a trash can receptacle;
weighing the received said trash or said recyclables;
determining a monetary value of the received said trash or said recyclables based on stored pricing algorithms;
displaying on a display screen said determined monetary value and a determined weight of said trash or said recyclables; and
dispensing said determined monetary value.

19. The method of claim 18, wherein said weighing including a weight sensor having a weight transducer to convert a weight of the received said trash or a weight of the received said recyclables into an electrical output signal for said displaying on said display screen.

20. The method of claim 19, wherein said dispensing said determined monetary value includes dispensing coins from a coin slot.
